(19) United States
(12) Patent Application Publication
(10) Pub. No.: US 2026/0127389 A1
(43) Pub. Date: May 7, 2026

(54) RESPONSE GENERATION DEVICE AND METHOD

(71) Applicant: HTC Corporation, Taoyuan City (TW)

(72) Inventors: Chen-Han TSAI, Taoyuan City (TW); Yu-Shao PENG, Taoyuan City (TW)

(21) Appl. No.: 19/382,265

(22) Filed: Nov. 7, 2025

Related U.S. Application Data
(60) Provisional application No. 63/717,825, filed on Nov. 7, 2024.

(51) Int. Cl. G06F 40/40; G06F 40/35

(52) U.S. Cl. CPC G06F 40/40; G06F 40/35

(57) ABSTRACT

A response generation device and method are provided. The device stores a language model and a response verification model. Based on a user conversation and the language model, the device generates a first response corresponding to the user conversation. The device determines whether the first response corresponds to a verification failed state based on the user conversation, verification indicators, and the response verification model. In response to determining that the first response corresponds to the verification failed state, the device generates a second response corresponding to the user conversation.

### CROSS-REFERENCE TO RELATED APPLICATION

This application claims priority to U.S. Provisional Application Ser. No. 63/717,825, filed Nov. 7, 2024, which is herein incorporated by reference in its entirety.

### BACKGROUND

### Field of Invention

The present disclosure relates to a response generation device and method. More particularly, the present disclosure relates to a response generation device and method that can actively verify whether the response generated by a language model is appropriate.

### Description of Related Art

With the recent rise of artificial intelligence and its related applications, users can interact with chatbots and obtain a variety of information responses from them.

However, modern language model-based chatbots may misunderstand the user's intentions for various reasons, mistakenly generating inappropriate responses that fail to meet the user's needs. In such cases, poor responses can lead to user dissatisfaction with the language model chatbot.

In the existing technology, chatbots trained based on language models can take preventive measures during development (for example, safely adjusting unsafe inputs during supervised fine-tuning (SFT) and using reinforcement learning from human feedback (RLHF) for safe training) to ensure the safety of the chatbot's responses.

However, these preventative measures only ensure the rationality of responses during the first-level training phase, but fail to provide the second-level verification during operation to ensure that the chatbot's responses are accurate. Therefore, such language model-based chatbots are still prone to making inappropriate responses to user input (e.g., Large Language Model jailbreaking).

Accordingly, there is an urgent need for a response generation technology that can actively verify whether the response generated by the language model is appropriate.

### SUMMARY

An objective of the present disclosure is to provide a response generation device. The response generation device comprises a storage, a transceiver interface, and a processor. The processor is electrically connected to the storage and the transceiver interface. The storage stores a language model and a response verification model. The processor generates, based on a user conversation and the language model, a first response corresponding to the user conversation. The processor determines whether the first response corresponds to a verification failed state based on the user conversation, a plurality of verification indicators, and the response verification model. In response to determining that the first response corresponds to the verification failed state, the processor generates a second response corresponding to the user conversation.

Another objective of the present disclosure is to provide a response generation method, which is adapted for use in an electronic device. The electronic device stores a language model and a response verification model. The response generation method comprises the following steps: generating, based on a user conversation and the language model, a first response corresponding to the user conversation; determining whether the first response corresponds to a verification failed state based on the user conversation, a plurality of verification indicators, and the response verification model; and in response to determining that the first response corresponds to the verification failed state, generating a second response corresponding to the user conversation.

According to the above descriptions, the response generation technology provided by the present disclosure (at least including the device and the method) can actively determine whether the response generated by the model has passed verification based on a plurality of verification indicators. Then, in response to determining that the response has not passed verification, the response generation technology provided by the present disclosure generates a new response or modifies the previous response. Finally, the response generation technology provided by the present disclosure can provide the response to the user only after confirming that the generated response meets the verification indicators. Since the response generation technology provided by the present disclosure actively provides a mechanism for verifying the response and modifies the response through different response generation mechanisms, it can ensure the security of the response ultimately provided to the user, solve the problems of the existing technology, and enhance the user's conversation experience.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a response generation device of some embodiments;

FIG. 2 is a schematic view depicting a response generation device of some embodiments;

FIG. 3 is a schematic view depicting a response generation device of some embodiments;

FIG. 4 is a schematic view depicting a verification operation of some embodiments;

FIG. 5 is a schematic view depicting a verification operation of some embodiments;

FIG. 6 is a schematic view depicting a verification operation of some embodiments; and

FIG. 7 is a partial flowchart depicting a response generation method of the second embodiment.

### DETAILED DESCRIPTION

In the following description, a response generation device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

The problem that the present disclosure aims to solve is briefly described. Without a verification system to monitor responses, a language model-based chatbot (LM-Based Chatbot) may provide inappropriate responses to users, failing to resolve their issues and resulting in a poor service experience.

For example, when a user says to a chatbot, “I'm ready to end my life . . . ”, a chatbot that lacks a mechanism to verify the content of the response might directly respond with an inappropriate response, “Do you know what the meaning of life is?”. In this case, the chatbot's response fails to provide a sympathetic response and fails to resolve the user's problem.

Through the response generation mechanism disclosed in this disclosure, the content of the response can be proactively verified before providing the final version of the response to the user, and the response can be modified through various mechanisms to ensure the generation of safe and high-quality responses. This can solve the aforementioned problem of generating inappropriate responses.

First, the application scenarios of the present disclosure are briefly described. The present disclosure can set/execute the response generation device and method in an external system (e.g., a cloud server) or integrate it into a user device (e.g., a computer, a mobile phone). The present disclosure can determine whether the generated response is suitable for replying to the current conversation with the user based on various verification operations.

In addition, in subsequent applications, the response generation device/method disclosed herein can output the generated response in a suitable form to the user device (e.g., a chatbot window) to reply to the conversation with the user, thereby enhancing the conversation experience between the user and the chatbot.

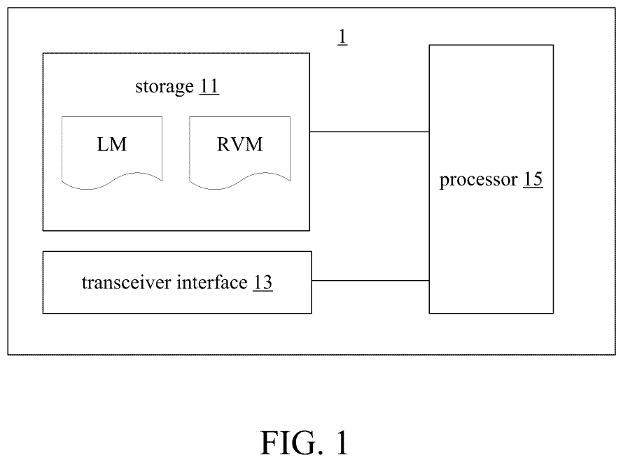

The first embodiment of the present disclosure is a response generation device 1, the structure of which is schematically depicted in FIG. 1. In this embodiment, the response generation device 1 comprises a storage 11, a transceiver interface 13, and a processor 15. The processor 15 is electrically connected to the storage 11 and the transceiver interface 13. In some embodiments, the transceiver interface 13 is communicatively connected to a user device (e.g., a computer operated by the user).

It shall be appreciated that the storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external devices, external web pages, external applications, and so on. The processor 15 may be any of various processors, Central Processing Units (CPUs), microprocessors, digital signal processors or other computing devices known to those of ordinary skill in the art.

In the present embodiment, as shown in FIG. 1, the storage 11 can store the language model LM and the response verification model RVM. Specifically, the language model LM is a large language model that has been trained. The language model LM can be used to generate responses corresponding to user input based on the user's input conversation and the user's prompt.

In addition, the response verification model RVM can be used to determine whether the response generated by the language model LM is suitable for the user conversation based on a plurality of pre-set verification indicators.

In some embodiments, the response verification model (RVM) can also be implemented using a trained large language model and user prompts. For example, the response verification model (RVM) can be trained using labeled training data (e.g., multiple historical user conversations and responses).

In some embodiments, to avoid wasting resources by frequently executing verification operations by the response generation device 1, the response generation device 1 may first determine the content of the current conversation with the user, and when it is determined that the verification operation initiation/adjustment conditions are met (e.g., the content/frequency of the user's conversation corresponds to a historical abnormal behavior, etc.), perform subsequent verification operations/adjust the operation frequency (e.g., increase the frequency of verification responses, etc.).

In some embodiments, the response generation device 1 can be configured to operate in different response modification/response generation modes according to different environments and application requirements.

For ease of explanation, the user conversation referred to below may, in some cases, be considered a conversation conducted by the user through the user device or response generation device 1 operated by the user (e.g., a user inputs a response on the user device and transmits it to the chatbot/response generation device 1). Furthermore, the response generation device 1 may record historical conversations with the user (e.g., the content of previous conversations) and refer to the context of the conversation content or the state of the conversation with the user during operation.

First, in this embodiment, the response generation device 1 can directly receive the user conversation (e.g., by the user directly inputting the conversation on the response generation device 1) or receive the user conversation from an external user device.

In some embodiments, the user conversation includes a current conversation and a plurality of historical conversations corresponding to a user.

Next, in this embodiment, the processor 15 generates an initial response corresponding to the user conversation using the language model LM. Specifically, the processor 15 generates a first response corresponding to the user conversation based on the user conversation and the language model LM.

Next, in this embodiment, the processor 15 verifies the content of the first response using the response verification model RVM. Specifically, the processor 15 determines whether the first response corresponds to a verification failed state based on the user conversation, a plurality of verification indicators, and the response verification model RVM.

In some embodiments, the processor 15 may determine whether the verification indicators are passed one by one. When one of the verification indicators fails to pass the test, the processor 15 determines that the response has failed verification. Specifically, the processor 15 determines a verification result of each of the plurality of verification indicators corresponding to the first response using the response verification model RVM. Then, in response to at least one of the verification results being determined to be a failed state, the processor 15 determines that the first response corresponds to the verification failed state.

It shall be appreciated that the response verification model RVM can better understand the context of the current response based on the historical conversation record. For example, the response verification model RVM can be implemented using a large language model or an embedding model.

It shall be appreciated that when using a large language model to evaluate responses, the large language model can be trained using prompts or similar data. For example, the input to the large language model must include the current response and can optionally include historical data. The large language model can predict each classification (e.g., repetitive? lack of empathy?) individually or simultaneously. The large language model's answer is then parsed and mapped to its allowed values (defined during the rubric setting).

It shall be appreciated that when using an embedding model to evaluate responses, the embedding model can be used as a classification model. For example, a fully connected layer is attached to the existing embedding model, and the dimension of the fully connected layer must be large enough to support all possible items in the scoring criteria (e.g., rubric). In addition, training data containing labeled items (e.g., scoring criteria) is provided in advance to train the embedding model. During response evaluation, the current response is passed to the embedding model, which predicts each item in the rubric.

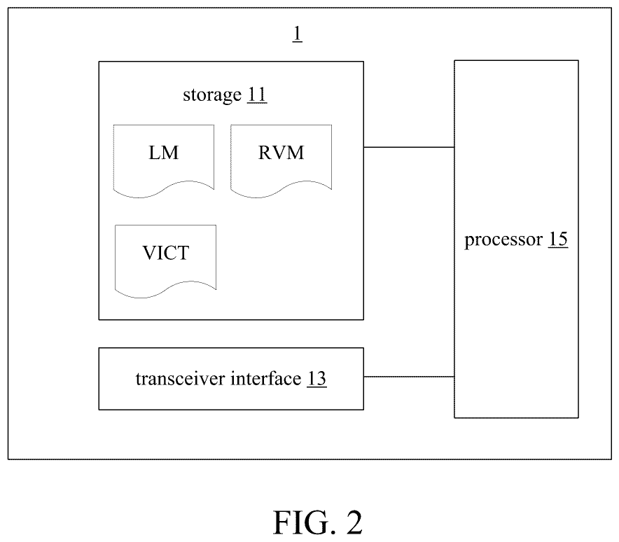

In some embodiments, as shown in FIG. 2, the storage 11 further stores a verification indicator comparison table VICT, which includes the verification indicators (e.g., flag values) and a rubric corresponding to each of the verification indicators (e.g., relevance, threshold value, etc.). Specifically, the processor 15 determines whether the first response corresponds to the verification failed state based on the user conversation, the verification indicator comparison table VICT, and the response verification model RVM.

For example, Table 1 illustrates a verification indicator comparison table VICT containing multiple verification indicators (for example, the classification items in Table 1 below):

TABLE 1

| Classification Item | Value |
|---|---|
| Is Repeat? | FALSE |
| Has Toxic content? | FALSE |
| Contains Cliché? | FALSE |
| Lacks Empathy? | TRUE |

In this example, the classification items in the verification indicator comparison table VICT include four verification indicators: “Is Repeat?”, “Has Toxic content?”, “Contains Cliché?”, and “Lacks Empathy?”.

In this example, the processor 15 determines that the content of the response lacks empathy, and therefore sets the judgment value for “Lacks Empathy?” to yes, and determines that the first response corresponds to the verification failed state.

In some embodiments, the processor 15 can directly generate and update a new verification indicator comparison table based on a text description (e.g., a user prompt). Specifically, the processor 15 generates a new verification indicator comparison table and a new rubric corresponding to each of a plurality of new verification indicators based on a text description to update the verification indicator comparison table VICT. Then, the processor 15 determines whether the first response corresponds to the verification failed state based on the new verification indicator comparison table and the response verification model RVM.

It shall be appreciated that the rubric definition can be automatically generated by the processor 15 (e.g., using a large language model) or defined by a professional. Furthermore, after the rubric is defined, the processor 15 can apply an evaluation function to the values in the rubric to determine whether the answer is a pass or fail.

In some embodiments, the values in the rubric can be numeric, categorical, or Boolean values.

Specifically, the processor 15 may analyze the text description using a rubric converter (e.g., a D2R converter) to generate a table corresponding to the description. Furthermore, the processor 15 may consider using a learned evaluation function, where the language model suggests a function that maps the content of the rubric to a “pass” or “fail” sample based on a given description. The definition of the evaluation function should consider all possible value combinations in the rubric.

For example, one possible method for implementing a learning evaluation function is to use a classifier such as XGBoost or CatBoost. These learning functions utilize training data in which each sample is associated with a “pass” or “fail” label. Furthermore, the processor 15 can optimize all training samples to implement an evaluation function that accepts a rubric as input and outputs a “pass” or “fail” classification result. Historical feedback in the training data can be evaluated by existing experts (e.g., psychologists) to train a response verification model RVM based on the training data. In some embodiments, sensitive information in historical conversations can be anonymized to hide personal information.

In some embodiments, before verifying any response, the response generation device 1 may determine whether the response is “passed” or “failed.” For example, the processor 15 may define verification indicator weights, passing criteria (e.g., all or some of the verification indicators), and other criteria.

Next, in this embodiment, the processor 15 generates a second response corresponding to the user conversation in response to determining that the first response corresponds to the verification failed state.

In some embodiments, when verification is successful (i.e., all verification indicators are passed), the current response can be set as a target response to notify the user. Specifically, the processor 15 determines whether the second response corresponds to the verification failed state based on the user conversation, the verification indicators, and the response verification model RVM. Then, in response to determining that the second response does not correspond to the verification failed state, the processor 15 sets the second response as a target response corresponding to the user conversation.

In some embodiments, the transceiver interface 13 is communicatively connected to a user device, the user conversation is transmitted from the user device, and the target response is output by the user device. Specifically, the processor 15 transmits the target response corresponding to the user conversation to the user device to make the user device play the target response.

In some embodiments, different domain-specific response verification models RVMs may be used for different target domains to improve verification accuracy. Specifically, the processor 15 may determine the user conversation and select a domain-specific response verification model (RVM).

It shall be appreciated that in this disclosure, the second response may be generated by a variety of different mechanisms. The following paragraphs will describe in detail the specific implementation details of each mechanism.

In some embodiments, the chatbot may generate a response again directly from the language model LM. Specifically, the processor 15 generates a second response corresponding to the user conversation based on the user conversation and the language model LM, and the second response is different from the first response.

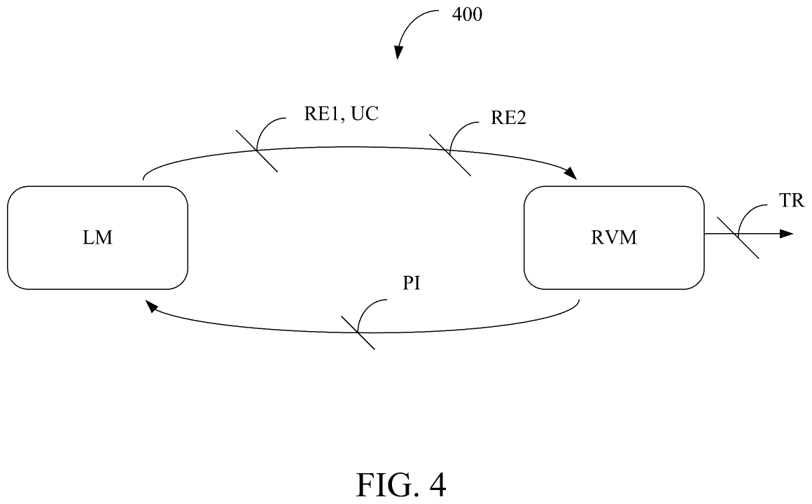

For example, please refer to the operation diagram 400 of FIG. 4. In this example, the language model LM transmits the first response RE1 and the user conversation UC to the response verification model RVM. Then, after the response verification model RVM determines that the first response RE1 corresponds to the verification failed state, it generates a prompt instruction PI to the language model LM to make the language model LM directly regenerate the second response RE2. Finally, after the response verification model RVM determines that the second response RE2 corresponds to the verified state, it sets the second response RE2 as the target response TR corresponding to the user conversation UC and provides it to the user.

In some embodiments, the chatbot can adjust its response based on the feedback of the response verification model RVM. Specifically, in response to determining that the first response corresponds to the verification failed state, the processor 15 generates a feedback corresponding to the first response based on the verification result of each of the verification indicators by the response verification model RVM, wherein the feedback is used to indicate at least one of the verification indicators that is determined to be in the failed state. Then, the processor 15 generates the second response corresponding to the user conversation based on the user conversation, the feedback, and the language model LM.

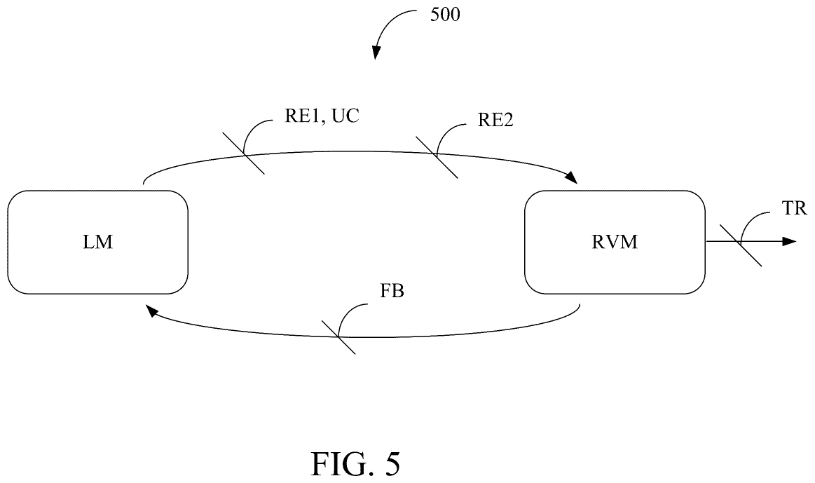

For example, please refer to the operation diagram 500 of FIG. 5. In this example, the language model LM transmits the first response RE1 and the user conversation UC to the response verification model RVM. Then, after the response verification model RVM determines that the first response RE1 corresponds to the verification failed state, it generates a feedback FB to the language model LM, so that the language model LM regenerates the second response RE2 based on the feedback FB. Finally, after the response verification model RVM determines that the second response RE2 corresponds to the verified state, it sets the second response RE2 as the target response TR corresponding to the user conversation UC and provides it to the user.

It shall be appreciated that the feedback FB may include information or prompts for adjusting the answer (e.g., reasons for verification failure, verification indicators, etc.). The purpose of the feedback FB is to provide some feedback information for the response modification stage. The feedback FB can be achieved by simply providing the evaluation rubric and the judgment result (i.e., pass or fail) in text form.

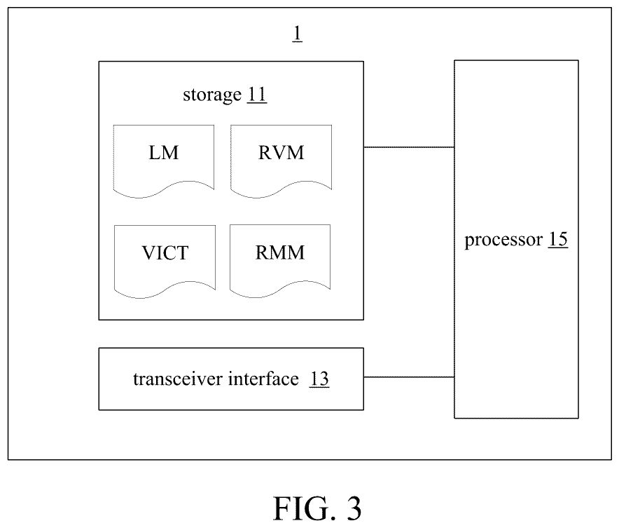

In some embodiments, the processor 15 may adjust the content through another model instead of regenerating the response. As shown in FIG. 3, the storage 11 further stores a response modification model RMM, and the processor 15 adjusts the response through the response modification model RMM. Specifically, in response to determining that the first response corresponds to the verification failed state, the processor 15 generates a feedback corresponding to the first response based on the verification result of each of the verification indicators by the response verification model RVM, and the feedback is used to indicate at least one of the verification indicators that is determined to be in the failed state. Then, the processor 15 generates the second response corresponding to the user conversation based on the first response, the feedback and the response modification model RMM.

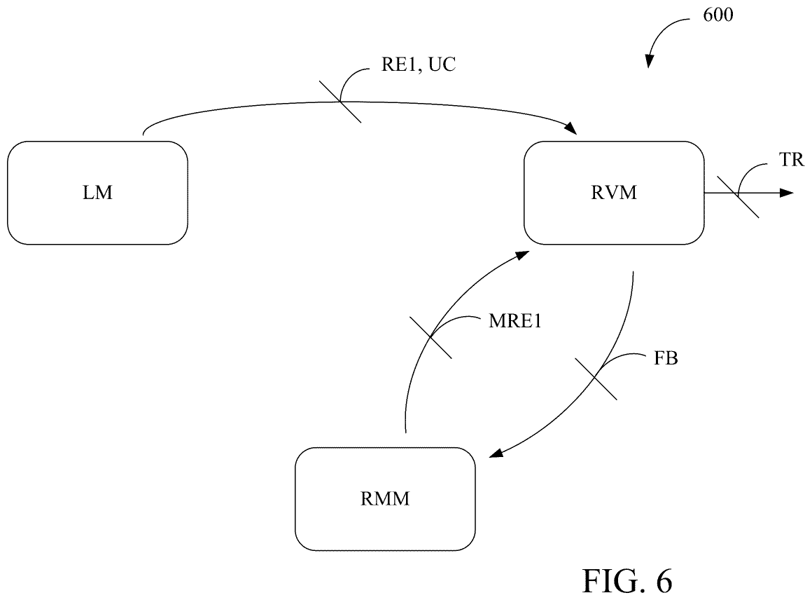

For example, please refer to the operation diagram 600 of FIG. 6. In this example, the language model LM transmits the first response RE1 and the user conversation UC to the response verification model RVM. Then, after the response verification model RVM determines that the first response RE1 corresponds to the verification failed state, it generates a feedback FB to the response modification model RMM. Then, the response modification model RMM modifies the first response RE1 based on the feedback FB to generate a modified response MRE1 (i.e., the second response referred to in some embodiments). Finally, after the response verification model RVM determines that the modified response MRE1 corresponds to the verified state, it sets the modified response MRE1 as the target response TR corresponding to the user conversation UC and provides it to the user.

In some embodiments, the response modification model RMM can be generated after training another large language model based on historical training data (e.g., multiple historical user conversations and response content).

In some embodiments, the processor 15 may verify the second response, and when the second response fails verification, continue to generate a third response based on any of the aforementioned operations. Specifically, the processor 15 determines whether the second response corresponds to the verification failed state based on the user conversation, the verification indicators, and the response verification model RVM. Then, in response to determining that the second response corresponds to the verification failed state, the processor 15 generates a third response corresponding to the user conversation, and the third response is different from the second response.

In some embodiments, the processor 15 may iteratively perform the aforementioned feedback and modification operations multiple times until all indicators meet the specified conditions or a stop condition is met. Alternatively, the processor 15 may modify one verification indicator at a time and repeat the process until all verification indicators meet the specified conditions.

For example, the processor 15 may repeatedly verify the response based on the aforementioned operation until all verification indicators are met. For another example, the processor 15 may also set an upper limit on the number of verifications to limit the number of executions.

In some embodiments, the processor 15 may employ different response generation methods depending on different application scenarios to avoid response delays. For example, in a relatively static scenario, the processor 15 may employ a regeneration method to generate responses. When the scene is more dynamic, the processor 15 can improve the response rate by modifying the response method.

In some embodiments, the conversation between the response generating device 1 and the user can be displayed to the user in real time through multiple display contents on the display interface of the response generation device 1.

According to the above descriptions, the response generation device 1 provided by the present disclosure can actively determine whether the response generated by the model has passed verification based on a plurality of verification indicators. Then, in response to determining that the response has not passed verification, the response generation device 1 provided by the present disclosure generates a new response or modifies the previous response. Finally, the response generation device 1 provided by the present disclosure can provide the response to the user only after confirming that the generated response meets the verification indicators. Since the response generation device 1 provided by the present disclosure actively provides a mechanism for verifying the response and modifies the response through different response generation mechanisms, it can ensure the security of the response ultimately provided to the user, solve the problems of the existing technology, and enhance the user's conversation experience.

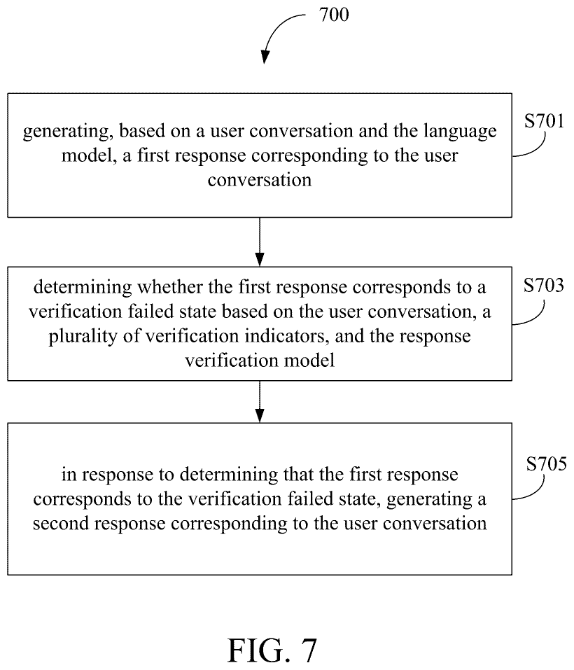

A second embodiment of the present invention is a response generation method and a flowchart thereof is depicted in FIG. 7. The response generation method 700 is adapted for use in an electronic device (e.g., the response generation device 1 of the first embodiment). The electronic device stores a language model and a response verification model. The response generation method 700 verifies and generates a suitable response corresponding to the user conversation through the steps S701 to S705.

First, in the step S701, the electronic device generates, based on a user conversation and the language model, a first response corresponding to the user conversation.

Next, in the step S703, the electronic device determines whether the first response corresponds to a verification failed state based on the user conversation, a plurality of verification indicators, and the response verification model.

Finally, in the step S705, in response to determining that the first response corresponds to the verification failed state, the electronic device generates a second response corresponding to the user conversation.

In some embodiments, the response generation method 700 further comprises the following steps: determining, through the response verification model, a verification result of each of the plurality of verification indicators corresponding to the first response; and in response to at least one of the verification results being determined to be a failed state, determining that the first response corresponds to the verification failed state.

In some embodiments, wherein the second response is generated based on the following steps: generating the second response corresponding to the user conversation based on the user conversation and the language model, wherein the second response is different from the first response.

In some embodiments, wherein the second response is generated based on the following steps: in response to determining that the first response corresponds to the verification failed state, generating a feedback corresponding to the first response by the response verification model based on the verification result of each of the verification indicators, wherein the feedback is used to indicate at least one of the verification indicators that is determined to be in the failed state; and generating the second response corresponding to the user conversation based on the user conversation, the feedback, and the language model.

In some embodiments, the electronic device further stores a response modification model, and the second response is generated based on the following steps: in response to determining that the first response corresponds to the verification failed state, generating a feedback corresponding to the first response based on the verification result of each of the verification indicators by the response verification model, wherein the feedback is used to indicate at least one of the verification indicators that is determined to be in the failed state; and generating the second response corresponding to the user conversation based on the first response, the feedback, and the response modification model.

In some embodiments, the response generation method 700 further comprises the following steps: determining whether the second response corresponds to the verification failed state based on the user conversation, the verification indicators, and the response verification model; and in response to determining that the second response corresponds to the verification failed state, generating a third response corresponding to the user conversation, wherein the third response is different from the second response.

In some embodiments, the response generation method 700 further comprises the following steps: determining whether the second response corresponds to the verification failed state based on the user conversation, the verification indicators, and the response verification model; and in response to determining that the second response does not correspond to the verification failed state, setting the second response as a target response corresponding to the user conversation.

In some embodiments, the electronic device is communicatively connected to a user device, and the user conversation is transmitted from the user device, and the response generation method 700 further comprises the following steps: transmitting the target response corresponding to the user conversation to the user device to make the user device play the target response.

In some embodiments, the electronic device further stores a verification indicator comparison table, the verification indicator comparison table comprises the verification indicators and a rubric corresponding to each of the verification indicators, and the step of determining whether the first response corresponds to the verification failed state further comprises the following steps: determining whether the first response corresponds to the verification failed state based on the user conversation, the verification indicator comparison table, and the response verification model.

In some embodiments, the electronic device further stores a verification indicator comparison table, the verification indicator comparison table comprises the verification indicators and a rubric corresponding to each of the verification indicators, and the response generation method further comprises the following steps: generating, based on a text description, a new verification indicator comparison table and a new rubric corresponding to each of the plurality of new verification indicators to update the verification indicator comparison table; and determining whether the first response corresponds to the verification failed state based on the new verification indicator comparison table and the response verification model.

In addition to the aforesaid steps, the second embodiment can also execute all the operations and steps of the response generation device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., the feedback) are preceded by terms such as “first”, “second”, or “third”, and these terms of “first”, “second”, or “third” are only used to distinguish these different words. For example, the “first” and “second” in the first feedback and the second feedback are only used to indicate the different feedback.

According to the above descriptions, the response generation technology provided by the present disclosure (at least including the device and the method) can actively determine whether the response generated by the model has passed verification based on a plurality of verification indicators. Then, in response to determining that the response has not passed verification, the response generation technology provided by the present disclosure generates a new response or modifies the previous response. Finally, the response generation technology provided by the present disclosure can provide the response to the user only after confirming that the generated response meets the verification indicators. Since the response generation technology provided by the present disclosure actively provides a mechanism for verifying the response and modifies the response through different response generation mechanisms, it can ensure the security of the response ultimately provided to the user, solve the problems of the existing technology, and enhance the user's conversation experience.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A response generation device, comprising:
a storage, storing a language model and a response verification model;
a transceiver interface; and
a processor, being electrically connected to the storage and the transceiver interface, and being configured to perform operations comprising:
generating, based on a user conversation and the language model, a first response corresponding to the user conversation;
determining whether the first response corresponds to a verification failed state based on the user conversation, a plurality of verification indicators, and the response verification model; and
in response to determining that the first response corresponds to the verification failed state, generating a second response corresponding to the user conversation.

2. The response generation device of claim 1, wherein the processor further performs the following operations:
determining, through the response verification model, a verification result of each of the plurality of verification indicators corresponding to the first response; and
in response to at least one of the verification results being determined to be a failed state, determining that the first response corresponds to the verification failed state.

3. The response generation device of claim 1, wherein the second response is generated based on the following operations:
generating the second response corresponding to the user conversation based on the user conversation and the language model, wherein the second response is different from the first response.

4. The response generation device of claim 2, wherein the second response is generated based on the following operations:
in response to determining that the first response corresponds to the verification failed state, generating a feedback corresponding to the first response by the response verification model based on the verification result of each of the verification indicators, wherein the feedback is used to indicate at least one of the verification indicators that is determined to be in the failed state; and
generating the second response corresponding to the user conversation based on the user conversation, the feedback, and the language model.

5. The response generation device of claim 2, wherein the storage further stores a response modification model, and the second response is generated based on the following operations:
in response to determining that the first response corresponds to the verification failed state, generating a feedback corresponding to the first response based on the verification result of each of the verification indicators by the response verification model, wherein the feedback is used to indicate at least one of the verification indicators that is determined to be in the failed state; and
generating the second response corresponding to the user conversation based on the first response, the feedback, and the response modification model.

6. The response generation device of claim 1, wherein the processor further performs the following operations:
determining whether the second response corresponds to the verification failed state based on the user conversation, the verification indicators, and the response verification model; and
in response to determining that the second response corresponds to the verification failed state, generating a third response corresponding to the user conversation, wherein the third response is different from the second response.

7. The response generation device of claim 1, wherein the processor further performs the following operations:
determining whether the second response corresponds to the verification failed state based on the user conversation, the verification indicators, and the response verification model; and
in response to determining that the second response does not correspond to the verification failed state, setting the second response as a target response corresponding to the user conversation.

8. The response generation device of claim 7, wherein the transceiver interface is communicatively connected to a user device, and the user conversation is transmitted from the user device, and the processor further performs the following operations:
transmitting the target response corresponding to the user conversation to the user device to make the user device play the target response.

9. The response generation device of claim 1, wherein the storage further stores a verification indicator comparison table, the verification indicator comparison table comprises the verification indicators and a rubric corresponding to each of the verification indicators, and the operation of determining whether the first response corresponds to the verification failed state further comprises the following operations:
determining whether the first response corresponds to the verification failed state based on the user conversation, the verification indicator comparison table, and the response verification model.

10. The response generation device of claim 1, wherein the storage further stores a verification indicator comparison table, the verification indicator comparison table comprises the verification indicators and a rubric corresponding to each of the verification indicators, and the processor further performs the following operations:
generating, based on a text description, a new verification indicator comparison table and a new rubric corresponding to each of a plurality of new verification indicators to update the verification indicator comparison table; and
determining whether the first response corresponds to the verification failed state based on the new verification indicator comparison table and the response verification model.

11. A response generation method, being adapted for use in an electronic device, wherein the electronic device stores a language model and a response verification model, and the response generation method comprises the following steps:
generating, based on a user conversation and the language model, a first response corresponding to the user conversation;
determining whether the first response corresponds to a verification failed state based on the user conversation, a plurality of verification indicators, and the response verification model; and
in response to determining that the first response corresponds to the verification failed state, generating a second response corresponding to the user conversation.

12. The response generation method of claim 11, wherein the response generation method further comprises the following steps:
determining, through the response verification model, a verification result of each of the plurality of verification indicators corresponding to the first response; and
in response to at least one of the verification results being determined to be a failed state, determining that the first response corresponds to the verification failed state.

13. The response generation method of claim 11, wherein the second response is generated based on the following steps:
generating the second response corresponding to the user conversation based on the user conversation and the language model, wherein the second response is different from the first response.

14. The response generation method of claim 12, wherein the second response is generated based on the following steps:
in response to determining that the first response corresponds to the verification failed state, generating a feedback corresponding to the first response by the response verification model based on the verification result of each of the verification indicators, wherein the feedback is used to indicate at least one of the verification indicators that is determined to be in the failed state; and
generating a second response corresponding to the user conversation based on the user conversation, the feedback, and the language model.

15. The response generation method of claim 12, wherein the electronic device further stores a response modification model, and the second response is generated based on the following steps:
in response to determining that the first response corresponds to the verification failed state, generating a feedback corresponding to the first response based on the verification result of each of the verification indicators by the response verification model, wherein the feedback is used to indicate at least one of the verification indicators that is determined to be in the failed state; and
generating the second response corresponding to the user conversation based on the first response, the feedback, and the response modification model.

16. The response generation method of claim 11, wherein the response generation method further comprises the following steps:
determining whether the second response corresponds to the verification failed state based on the user conversation, the verification indicators, and the response verification model; and
in response to determining that the second response corresponds to the verification failed state, generating a third response corresponding to the user conversation, wherein the third response is different from the second response.

17. The response generation method of claim 11, wherein the response generation method further comprises the following steps:
determining whether the second response corresponds to the verification failed state based on the user conversation, the verification indicators, and the response verification model; and
in response to determining that the second response does not correspond to the verification failed state, setting the second response as a target response corresponding to the user conversation.

18. The response generation method of claim 17, wherein the electronic device is communicatively connected to a user device, and the user conversation is transmitted from the user device, and the response generation method further comprises the following steps:
transmitting the target response corresponding to the user conversation to the user device to make the user device play the target response.

19. The response generation method of claim 11, wherein the electronic device further stores a verification indicator comparison table, the verification indicator comparison table comprises the verification indicators and a rubric corresponding to each of the verification indicators, and the step of determining whether the first response corresponds to the verification failed state further comprises the following steps:
determining whether the first response corresponds to the verification failed state based on the user conversation, the verification indicator comparison table, and the response verification model.

20. The response generation method of claim 11, wherein the electronic device further stores a verification indicator comparison table, the verification indicator comparison table comprises the verification indicators and a rubric corresponding to each of the verification indicators, and the response generation method further comprises the following steps:
generating, based on a text description, a new verification indicator comparison table and a new rubric corresponding to each of a plurality of new verification indicators to update the verification indicator comparison table; and
determining whether the first response corresponds to the verification failed state based on the new verification indicator comparison table and the response verification model.
